(19) United States
(12) Patent Application Publication
(10) Pub. No.: US 2025/0253461 A1
(43) Pub. Date: Aug. 7, 2025

(54) Battery Box and Battery Pack Applying the Same

(71) Applicant: EVE ENERGY CO., LTD., Huizhou (CN)

(72) Inventor: Jun Zhang, Huizhou (CN)

(21) Appl. No.: 18/827,864

(22) Filed: Sep. 9, 2024

(30) Foreign Application Priority Data
Feb. 6, 2024 (CN) 202420287102.5

(51) Int. Cl. H01M 50/233; H01M 50/262; H01M 50/271

(52) U.S. Cl. CPC H01M 50/233; H01M 50/262; H01M 50/271

(57) ABSTRACT

Disclosed are a battery box and a battery pack applying the same. The battery box includes a bottom plate, a lateral plate, a lower support, a partition, and an upper support, in which a top surface of the bottom plate is provided with a first protrusion, the lateral plates are provided perpendicular to the bottom plate on two opposite edges of the bottom plate, an interior side of the lateral plate is arranged with a first snap-block and a second snap-block along an extension direction, two opposite ends of the lower support are provided on the first snap-block respectively, two opposite ends of the partition are fixedly connected to the second snap-block respectively, a top of the partition is provided with a second protrusion, and two opposite ends of the upper support are provided on the second snap-block respectively.

### CROSS REFERENCE TO RELATED APPLICATIONS

The present disclosure claims the priority of Chinese Patent Application No. 202420287102.5 filed on Feb. 6, 2024 before CNIPA. All the above are hereby incorporated by reference in their entirety.

### TECHNICAL FIELD

The present disclosure relates to the technical field of batteries and, particularly, to a battery box and a battery pack applying the same.

### BACKGROUND

Most of the battery packs currently on the market adopt a battery box that only allows for a single deck of cells to be set up. As the electric vehicle evolves, the demand for energy density of the battery packs is getting increasingly high, and the existing single deck structure is no longer able to meet the market demand.

### SUMMARY

Most of the current battery pack boxes only allow a single deck of cells to be set up, and the space utilization inside the battery pack is insufficient.

Provided in a first aspect of the present disclosure is a battery box, including:
a bottom plate, in which a top surface of the bottom plate is provided with a first protrusion;
lateral plates, in which the lateral plates are provided perpendicular to the bottom plate on two opposite edges of the bottom plate, an interior side of the lateral plate is arranged with a first snap-block and a second snap-block along an extension direction thereof, and the first snap-block is closer to the bottom plate than the second snap-block;
a lower support, in which two opposite ends of the lower support are provided on the first snap-block respectively, a bottom of the lower support is abutted against a first protrusion, and a top of the lower support is arranged for placing cells;
a partition, in which two opposite ends of the partition are fixedly connected to the second snap-block respectively, and a top of the partition is provided with a second protrusion; and
an upper support, in which two opposite ends of the upper support are provided on the second snap-block respectively, a bottom of the upper support is abutted against the second protrusion, and a top of the upper support is arranged for placing cells.

Provided in a second aspect of the present disclosure is a battery pack, including:
a battery box as mentioned above;
one or more first cells, in which the first cell is provided on a top surface of the lower support; and
one or more second cells, in which the second cell is provided on a top surface of the upper support.

In the battery box of the present disclosure, specific configurations are as follows. A top surface of the bottom plate is provided with a first protrusion, the lateral plates are provided perpendicular to the bottom plate on two opposite edges of the bottom plate, an interior side of the lateral plate is arranged with a first snap-block and a second snap-block along an extension direction thereof, the first snap-block is closer to the bottom plate than the second snap-block, two opposite ends of the lower support are provided on the first snap-block respectively, a bottom of the lower support is abutted against a first protrusion, a top of the lower support is arranged for placing cells, two opposite ends of the partition are fixedly connected to the second snap-block respectively, a top of the partition is provided with a second protrusion, two opposite ends of the upper support are provided on the second snap-block respectively, a bottom of the upper support is abutted against the second protrusion, and a top of the upper support is arranged for placing cells. Therefore, a double-deck structure is formed to achieve an arrangement of double deck of cells, which greatly improves the space utilization inside the battery pack, enhances the structural strength of the double-deck structure, and ensures the stability of the arrangement of the double deck of cells.

### BRIEF DESCRIPTION OF THE DRAWINGS

FIG. 1 is a diagram in a perspective view of the battery box in an embodiment;

FIG. 2 is a diagram in a section view of the battery box in an embodiment;

FIG. 3 is a diagram in a section view of the battery pack in an embodiment.

The meanings of the attached markings are as follows:
1 bottom plate; 11 first protrusion; 2 lateral plate; 21 first snap-block; 211 tab; 22 second snap-block; 3 lower support; 4 partition; 41 second protrusion; 5 upper support; 6 top cover; 61 groove; 7 connecting member; 80 filler; 81 first cell; 82 second cell; 9 end cover.

### DETAILED DESCRIPTION

### Embodiment 1

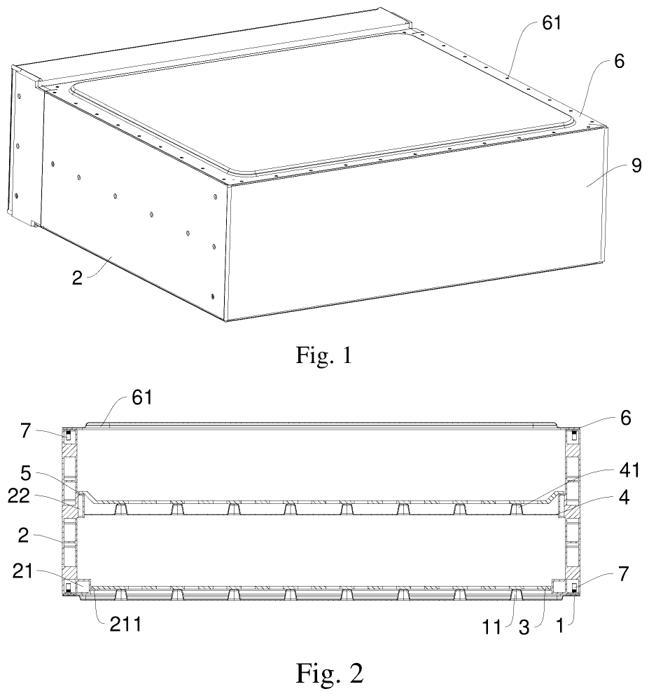

Referring to FIGS. 1-2, provided is a battery box, including a bottom plate 1, lateral plates 2, a lower support 3, a partition 4, and an upper support 5.

A top surface of the bottom plate 1 is provided with a first protrusion 11. The lateral plates 2 are provided perpendicular to the bottom plate 1 on two opposite edges of the bottom plate 1, an interior side of the lateral plate 2 is arranged with a first snap-block 21 and a second snap-block 22 along an extension direction thereof, that is, an interior side of the lateral plate 2 is arranged with the first snap-block 21 and the second snap-block 22 along a direction perpendicular to the bottom plate 1, and the first snap-block 21 is closer to the bottom plate 1 than the second snap-block 22. Two opposite ends of the lower support 3 are provided on the first snap-block 21 respectively, a bottom of the lower support 3 is abutted against a first protrusion 11, the first protrusion 11 serves to support the lower support 3, so that the lower support 3 is placed on a plane where an upper surface of the first protrusion 11 is positioned, and a top of the lower support 3 is arranged for placing cells. Two opposite ends of the partition 4 are fixedly connected to the second snap-block 22 respectively, a top of the partition 4 is provided with a second protrusion 41, and the second protrusion 41 serves to support the partition 4, so that the partition 4 is placed on a plane where an upper surface of the second protrusion 41. Two opposite ends of the upper support 5 are provided on the second snap-block 22 respectively, a bottom of the upper support 5 is abutted against the second protrusion 41, and a top of the upper support 5 is arranged for placing cells.

With the above configurations, a double-deck structure is formed to achieve an arrangement of double deck of cells, which greatly improves the space utilization inside the battery pack, enhances the structural strength of the double-deck structure, and ensures the stability of the arrangement of the double deck of cells.

In some implementations, the battery box further includes a top cover 6.

The top cover 6 is detachably connected to a top end of the lateral plate 2 and is perpendicular to the lateral plate 2. In some implementations, a bottom of the top cover 6 is concavely formed with a groove 61 in a direction distal to the upper support 5. In some implementations, a top of the lateral plate 2 is provided with first holes, edges of the top cover 6 are provided with connecting holes, and connecting members 7 are threaded through the first holes and the connecting holes, so that the top cover 6 is detachably connected to a top end of the lateral plate 2, in which the first holes and the connecting holes may be provided as screw holes, and accordingly, the connecting members 7 may be provided as screws.

By providing the top cover 6 detachably connected to the lateral plate 2, the battery inside the box is shielded and protected, and it is also easy to perform maintenance inside the box, so that the top cover 6 may be removed when the cells need to be replaced, thereby replacing the cells inside the box, and the top cover 6 may be mounted back again after the replacement.

Specifically, a top is a side facing upward in normal use, and a bottom is a side facing downward opposite to the top surface; accordingly, a top end is an end facing upward in normal use, and a bottom end is an end facing downward opposite to the top end.

More specifically, the lateral plates 2 are provided in a hollowed-out configuration. On the one hand, an overall weight of the lateral plate 2 is decreased 2, and on the other hand, the reinforcement ribs formed by the internal hollow out support the inner and outer sides of the lateral plates 2 respectively, so that the overall strength of the lateral plates 2 is strengthened. Optionally, a side of the first snap-block 21 is extended in a direction toward the lower support 3 to form a tab 211, that is, a side of the first snap-block 21 is extended inwardly to form a tab 211, and two opposite ends of the lower support 3 are provided on a top of the tab 211 respectively, so that the lower support 3 may be connected to the first snap-block 21 through a simpler and stabler structure.

In some implementations, bottom ends of the lateral plates 2 are detachably connected to two opposite edges of the bottom plate 1. In some implementations, a bottom end of the lateral plate 2 is provided with second holes, two opposite edges of the bottom plate 1 is provided with mounting holes, and connecting members 7 are threaded through the second holes and the mounting holes, so that the a bottom end of the lateral plate 2 is detachably connected to two opposite edges of the bottom plate 1, in which the second holes and the mounting holes may be provided as screw holes, and accordingly, the connecting members 7 may be provided as screws.

The lateral plates 2 and the bottom plate 1 form a detachable connection by means of the connecting member 7, which facilitates the disassembly of the lateral plates 2 for the maintenance of the lateral plates 2 themselves and the cells inside the box.

In some implementations, two other opposite edges of the bottom plate 1 may be provided with end plates, which form a space inside the box together with the lateral plate 2, for accommodating the cells and for protecting the cells inside the box.

### Embodiment 2

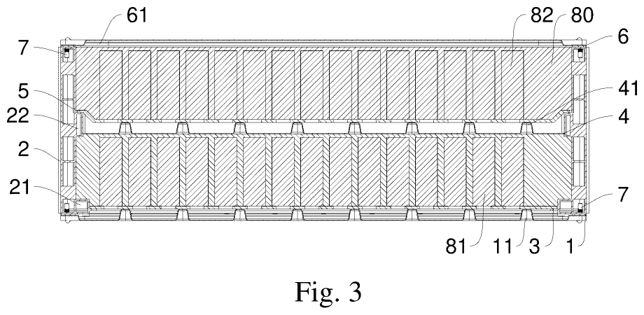

Referring to FIG. 3, based on the same concept, disclosed is further a battery pack, including a battery box as mentioned above, one or more first cells 81, and one or more second cells 82.

The first cell 81 is provided on a top of the lower support 3, the second cell 82 is provided on a top of the upper support 5, so as to form an arrangement of double deck of cells and improves the space utilization inside the battery pack.

In practical applications, the lower support 3 and the lateral plates 2 are enclosed to form a first filling space for filling a filler 80, so that the first cell 81 is fixedly provided on a top of the lower support 3; and/or, the upper support 5 and the lateral plates 2 are enclosed to form a second filling space for filling a filler 80, so that the second cell 82 is fixedly provided on a top of the upper support 3. The filler may be provided as polyurethane foam sealing agent, which facilitates filling the gap between each of the first cells 81, the space between the first cell 81 and the lateral plate 2 and the partition 4, the gap between each of the second cells 82, and the space between the second cells 82 and the lateral plate 2.

1. A battery box, comprising:
a bottom plate, wherein a top surface of the bottom plate is provided with a first protrusion;
lateral plates, wherein the lateral plates are provided perpendicular to the bottom plate on two opposite edges of the bottom plate, an interior side of the lateral plate is arranged with a first snap-block and a second snap-block along an extension direction thereof, and the first snap-block is closer to the bottom plate than the second snap-block;
a lower support, wherein two opposite ends of the lower support are provided on the first snap-block respectively, a bottom of the lower support is abutted against a first protrusion, and a top of the lower support is arranged for placing cells;
a partition, wherein two opposite ends of the partition are fixedly connected to the second snap-block respectively, and a top of the partition is provided with a second protrusion; and
an upper support, wherein two opposite ends of the upper support are provided on the second snap-block respectively, a bottom of the upper support is abutted against the second protrusion, and a top of the upper support is arranged for placing cells.

2. The battery box according to claim 1, further comprising:
a top cover, wherein the top cover is detachably connected to a top of the lateral plate and is perpendicular to the lateral plate.

3. The battery box according to claim 2, wherein a bottom of the top cover is concavely formed with a groove in a direction distal to the upper support.

4. The battery box according to claim 2, wherein a top end of the lateral plate is provided with first holes, edges of the top cover are provided with connecting holes, and connecting members are threaded through the first holes and the connecting holes, so that the top cover is detachably connected to a top end of the lateral plate.

5. The battery box according to claim 1, wherein the lateral plates are provided in a hollowed-out configuration.

6. The battery box according to claim 2, wherein the lateral plates are provided in a hollowed-out configuration.

7. The battery box according to claim 3, wherein the lateral plates are provided in a hollowed-out configuration.

8. The battery box according to claim 4, wherein the lateral plates are provided in a hollowed-out configuration.

9. The battery box according to claim 1, wherein a side of the first snap-block is extended in a direction toward the lower support to form a tab, and two opposite ends of the lower support are provided on a top of the tab respectively.

10. The battery box according to claim 2, wherein a side of the first snap-block is extended in a direction toward the lower support to form a tab, and two opposite ends of the lower support are provided on a top of the tab respectively.

11. The battery box according to claim 3, wherein a side of the first snap-block is extended in a direction toward the lower support to form a tab, and two opposite ends of the lower support are provided on a top of the tab respectively.

12. The battery box according to claim 4, wherein a side of the first snap-block is extended in a direction toward the lower support to form a tab, and two opposite ends of the lower support are provided on a top of the tab respectively.

13. The battery box according to claim 1, wherein bottom ends of the lateral plates are detachably connected to two opposite edges of the bottom plate.

14. The battery box according to claim 2, wherein bottom ends of the lateral plates are detachably connected to two opposite edges of the bottom plate.

15. The battery box according to claim 3, wherein bottom ends of the lateral plates are detachably connected to two opposite edges of the bottom plate.

16. The battery box according to claim 4, wherein bottom ends of the lateral plates are detachably connected to two opposite edges of the bottom plate.

17. The battery box according to claim 13, wherein a bottom end of the lateral plate is provided with second holes, two opposite edges of the bottom plate is provided with mounting holes, and connecting members are threaded through the second holes and the mounting holes, so that the a bottom end of the lateral plate is detachably connected to two opposite edges of the bottom plate.

18. A battery pack, comprising:
a battery box;
wherein the battery box comprises:
a bottom plate, wherein a top surface of the bottom plate is provided with a first protrusion;
lateral plates, wherein the lateral plates are provided perpendicular to the bottom plate on two opposite edges of the bottom plate, an interior side of the lateral plate is arranged with a first snap-block and a second snap-block along an extension direction thereof, and the first snap-block is closer to the bottom plate than the second snap-block;
a lower support, wherein two opposite ends of the lower support are provided on the first snap-block respectively, a bottom of the lower support is abutted against a first protrusion, and a top of the lower support is arranged for placing cells;
a partition, wherein two opposite ends of the partition are fixedly connected to the second snap-block respectively, and a top of the partition is provided with a second protrusion; and
an upper support, wherein two opposite ends of the upper support are provided on the second snap-block respectively, a bottom of the upper support is abutted against the second protrusion, and a top of the upper support is arranged for placing cells;
one or more first cells, wherein the first cell is provided on a top surface of the lower support; and
one or more second cells, wherein the second cell is provided on a top surface of the upper support.

19. The battery pack according to claim 18, wherein the battery box further comprises a top cover, and the top cover is detachably connected to a top of the lateral plate and is perpendicular to the lateral plate.

20. The battery pack according to claim 18, wherein the lower support and the lateral plates are enclosed to form a first filling space for filling a filler, so that the first cell is fixedly provided on a top of the lower support; and/or, the upper support and the lateral plates are enclosed to form a second filling space for filling a filler, so that the second cell is fixedly provided on a top of the upper support.
